(19) United States
(12) Patent Application Publication
(10) Pub. No.: US 2021/0384541 A1
(43) Pub. Date: Dec. 9, 2021

(54) REDOX FLOW BATTERY AND METHOD FOR MANUFACTURING METAL ION-CONDUCTING MEMBRANE INCLUDED IN REDOX FLOW BATTERY

(71) Applicant: Panasonic Intellectual Property Management Co., Ltd., Osaka (JP)

(72) Inventors: KOHEI HARA, Osaka (JP); MASAHISA FUJIMOTO, Osaka (JP); HONAMI SAKO, Osaka (JP); SHUJI ITO, Nara (JP)

(21) Appl. No.: 17/412,329

(22) Filed: Aug. 26, 2021

Related U.S. Application Data
(63) Continuation of application No. PCT/JP2020/011713, filed on Mar. 17, 2020.

(30) Foreign Application Priority Data
Jul. 12, 2019 (JP) 2019-129731

(51) Int. Cl. H01M 8/1053; H01M 8/18; H01M 8/1023; H01M 8/1039

(52) U.S. Cl. CPC H01M 8/1053; H01M 8/188; H01M 2300/0017; H01M 8/1039; H01M 8/1023

(57) ABSTRACT

A redox flow battery includes a negative electrode; a positive electrode; a first liquid which contains a first nonaqueous solvent, a first redox species, and metal ions and which is in contact with the negative electrode; a second liquid which contains a second nonaqueous solvent and which is in contact with the positive electrode; and a metal ion-conducting membrane disposed between the first liquid and the second liquid. The metal ion-conducting membrane includes a porous layer and a resin layer which is in contact with the porous layer and which contains a fluorocarbon resin. The porous layer includes a porous body and a filler which is located in pores of the porous body and which contains a fluorocarbon resin.

### BACKGROUND

### 1. Technical Field

The present disclosure relates to a redox flow battery and a method for manufacturing a metal ion-conducting membrane included in the redox flow battery.

### 2. Description of the Related Art

Japanese Unexamined Patent Application Publication No. 2019-16602 discloses an electrochemical cell including a separator including a first high-mechanical strength layer and a second high-mechanical strength layer. The first high-mechanical strength layer has a plurality of openings arranged in a first opening pattern. The second high-mechanical strength layer has a plurality of openings arranged in a second opening pattern. The first opening pattern and the second opening pattern are complementarily formed.

### SUMMARY

One non-limiting and exemplary embodiment provides a redox flow battery exhibiting high charge/discharge efficiency.

In one general aspect, the techniques disclosed here feature a redox flow battery including a negative electrode; a positive electrode; a first liquid which contains a first nonaqueous solvent, a first redox species, and metal ions and which is in contact with the negative electrode; a second liquid which contains a second nonaqueous solvent and which is in contact with the positive electrode; and a metal ion-conducting membrane disposed between the first liquid and the second liquid. The metal ion-conducting membrane includes a porous layer and a resin layer which is in contact with the porous layer and which contains a fluorocarbon resin. The porous layer includes a porous body and a filler which is located in pores of the porous body and which contains a fluorocarbon resin.

According to the present disclosure, a redox flow battery exhibiting high charge/discharge efficiency can be provided.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic view showing the schematic configuration of a redox flow battery according to an embodiment of the present disclosure;

FIG. 2 is a sectional view of a metal ion-conducting membrane included in the redox flow battery according to the present embodiment;

FIG. 3 is an illustration showing a method for manufacturing the metal ion-conducting membrane;

FIG. 4 is an illustration showing the operation of the redox flow battery shown in FIG. 1;

FIG. 5 is a graph showing results of a charge/discharge test for an electrochemical cell of Example 1; and

FIG. 6 is a graph showing results of a charge/discharge test for an electrochemical cell of Comparative Example 1.

### DETAILED DESCRIPTION

### Summary of Aspects of Present Disclosure

A redox flow battery according to a first aspect of the present disclosure includes a negative electrode; a positive electrode; a first liquid which contains a first nonaqueous solvent, a first redox species, and metal ions and which is in contact with the negative electrode; a second liquid which contains a second nonaqueous solvent and which is in contact with the positive electrode; and a metal ion-conducting membrane disposed between the first liquid and the second liquid. The metal ion-conducting membrane includes a porous layer and a resin layer which is in contact with the porous layer and which contains a fluorocarbon resin. The porous layer includes a porous body and a filler which is located in pores of the porous body and which contains a fluorocarbon resin.

According to the first aspect, the resin layer and the filler included in the metal ion-conducting membrane are swollen by the first liquid or the second liquid. The metal ions can pass through the resin layer and the filler through the first nonaqueous solvent or second nonaqueous solvent present in the swollen resin layer and the filler. Since the filler is located in the pores of the porous body, the filler is unlikely to be swollen by the first liquid or the second liquid as compared to the resin layer. Therefore, the first redox species is dissolved in the first nonaqueous solvent or second nonaqueous solvent present in the filler and hardly diffuses. Therefore, the metal ion-conducting membrane hardly allows the first redox species to pass therethrough and a crossover that the first redox species moves from the first liquid to the second liquid can be suppressed. Suppressing the crossover enables the redox flow battery to exhibit high charge/discharge efficiency.

In a second aspect of the present disclosure, in the redox flow battery according to, for example, the first aspect, the fluorocarbon resin contained in the filler may be the same as the fluorocarbon resin contained in the resin layer. According to the second aspect, the metal ion-conducting membrane can be prepared by a simple method.

In a third aspect of the present disclosure, in the redox flow battery according to, for example, the first or second aspect, the fluorocarbon resin contained in the resin layer may include polyvinylidene fluoride.

In a fourth aspect of the present disclosure, in the redox flow battery according to, for example, the third aspect, the weight-average molecular weight of the polyvinylidene fluoride may be greater than or equal to 300,000 and less than or equal to 1,200,000.

In a fifth aspect of the present disclosure, in the redox flow battery according to, for example, any one of the first to fourth aspect, the porosity of the porous body may be greater than or equal to 20% and less than or equal to 50%.

In a sixth aspect of the present disclosure, in the redox flow battery according to, for example, any one of the first to fifth aspect, the content of the fluorocarbon resin in the metal ion-conducting membrane may be greater than or equal to 16% by weight and less than or equal to 44% by weight.

In a seventh aspect of the present disclosure, in the redox flow battery according to, for example, any one of the first to sixth aspect, the porous body may contain porous glass.

According to the third to seventh aspects, the redox flow battery exhibits high charge/discharge efficiency.

In an eighth aspect of the present disclosure, in the redox flow battery according to, for example, any one of the first to seventh aspect, the thickness of the porous layer may be greater than or equal to 0.2 mm and less than or equal to 1.0 mm. According to the eighth aspect, since the thickness of the porous layer is greater than or equal to 0.2 mm, the metal ion-conducting membrane has sufficient mechanical strength. On the other hand, since the thickness of the porous layer is less than or equal to 1.0 mm, the resistance of the metal ions passing through the metal ion-conducting membrane is low. Furthermore, since the thickness of the porous layer is less than or equal to 1.0 mm, the redox flow battery has high volume energy density.

A method for manufacturing a metal ion-conducting membrane according to a ninth aspect of the present disclosure is a method for manufacturing the metal ion-conducting membrane included in the redox flow battery according to any one of the first to eighth aspects and includes

(1) forming a coating by applying a solution containing a fluorocarbon resin to a first surface of a layer including the porous body,

(2) filling the pores of the porous body with the solution, and

(3) forming the porous layer and the resin layer by drying the coating after or concurrently with (2).

According to the ninth aspect, in the redox flow battery, the metal ion-conducting membrane can be manufactured such that the metal ion-conducting membrane allows the metal ions to pass therethrough and hardly allows the first redox species to pass therethrough. According to the metal ion-conducting membrane, a crossover that the first redox species moves from the first liquid to the second liquid can be suppressed. Suppressing the crossover enables the redox flow battery to exhibit high charge/discharge efficiency.

In a tenth aspect of the present disclosure, in the manufacturing method according to, for example, the ninth aspect, (2) may be performed in such a manner that a pressure difference is created between a first space adjacent to the coating and a second space adjacent to a second surface of the layer that is opposite to the first surface.

In an eleventh aspect of the present disclosure, in the manufacturing method according to, for example, the tenth aspect, the pressure difference may be greater than or equal to 90 kPa and less than or equal to 99 kPa.

According to the tenth or eleventh aspect, the pores of the porous body can be readily filled with the solution containing the fluorocarbon resin.

Embodiments of the present disclosure are described below with reference to the accompanying drawings. The present disclosure is not limited to the embodiments below.

### EMBODIMENTS

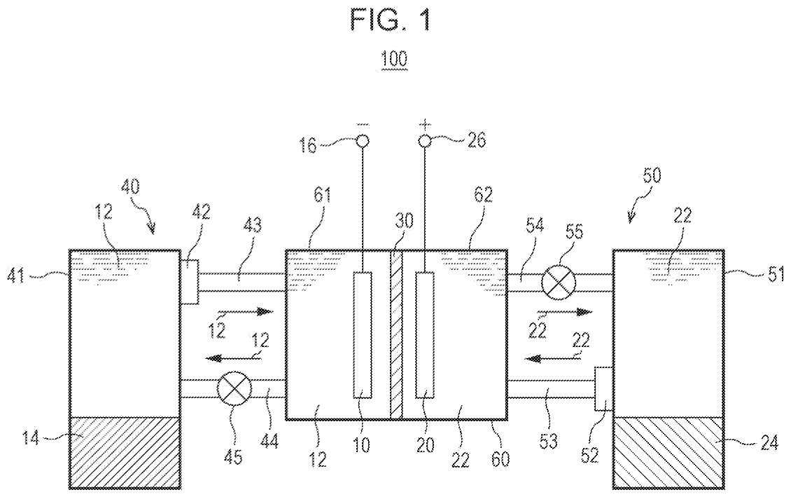

FIG. 1 is a schematic view showing the schematic configuration of a redox flow battery 100 according to an embodiment of the present disclosure. As shown in FIG. 1, the redox flow battery 100 includes a negative electrode 10, a positive electrode 20, a first liquid 12, a second liquid 22, and a metal ion-conducting membrane 30. The redox flow battery 100 may further include a negative electrode active material 14. The first liquid 12 contains a first nonaqueous solvent, a first redox species 18, and metal ions. The first liquid 12 is in contact with, for example, each of the negative electrode 10 and the negative electrode active material 14. In other words, each of the negative electrode 10 and the negative electrode active material 14 is immersed in the first liquid 12. At least a portion of the negative electrode 10 is in contact with the first liquid 12. The second liquid 22 contains a second nonaqueous solvent. The second liquid 22 is in contact with the positive electrode 20. In other words, the positive electrode 20 is immersed in the second liquid 22. At least a portion of the positive electrode 20 is in contact with the second liquid 22. The metal ion-conducting membrane 30 is disposed between the first liquid 12 and the second liquid 22 and isolates the first liquid 12 from the second liquid 22.

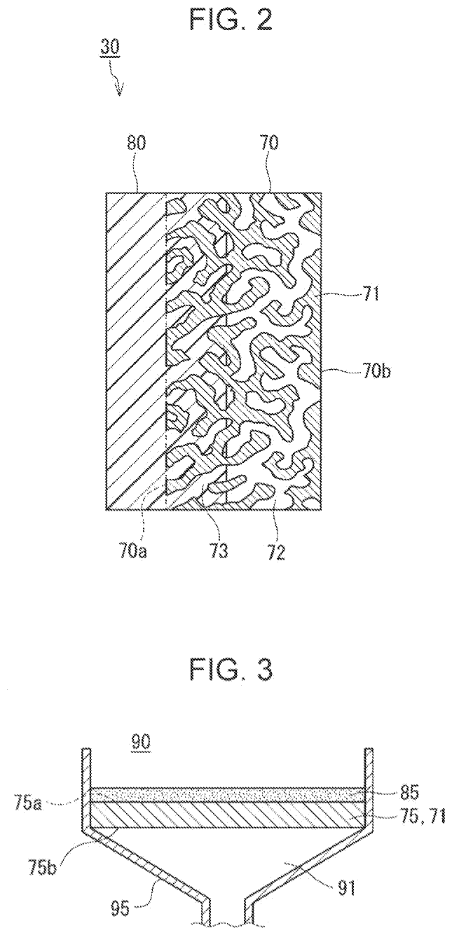

FIG. 2 is a sectional view of the metal ion-conducting membrane 30 included in the redox flow battery 100 according to the present embodiment. As shown in FIG. 2, the metal ion-conducting membrane 30 includes a porous layer 70 and a resin layer 80 in contact with the porous layer 70. The porous layer 70 has, for example, a first surface 70a and second surface 70b opposite to each other. Each of the first surface 70a and the second surface 70b is, for example, a principal surface of the porous layer 70. In the specification, the term “principal surface” refers to a surface of the porous layer 70 that has the largest area. For example, the first surface 70a of the porous layer 70 is in contact with a surface of the resin layer 80. In the redox flow battery 100, for example, the resin layer 80 is in contact with the first liquid 12, and the second surface 70b of the porous layer 70 is in contact with the second liquid 22. Incidentally, the resin layer 80 may be in contact with the second liquid 22, and the second surface 70b may be in contact with the first liquid 12.

The resin layer 80 covers, for example, the whole of the first surface 70a of the porous layer 70. Incidentally, the resin layer 80 may partly cover the first surface 70a. The resin layer 80 is, for example, nonporous and has a dense surface. Incidentally, the resin layer 80 may be porous.

The resin layer 80 contains a fluorocarbon resin. The resin layer 80 may contain the fluorocarbon resin as a major component or may consist essentially of the fluorocarbon resin. The term “major component” refers to a component present in the largest amount on a weight basis in the resin layer 80. The phrase “consist essentially of” means that another component varying an essential feature of the referred material is excluded. Incidentally, the resin layer 80 may contain an impurity in addition to the fluorocarbon resin. The fluorocarbon resin contains a polymer that is at least one selected from the group consisting of polyvinylidene fluoride (PVDF) and polyvinyl fluoride. The fluorocarbon resin contains, for example, PVDF. The fluorocarbon resin may contain PVDF as a major component or may consist essentially of PVDF. The weight-average molecular weight of the polymer contained in the fluorocarbon resin is, for example, greater than or equal to 300,000 and less than or equal to 1,200,000. The weight-average molecular weight of PVDF contained in the fluorocarbon resin is, for example, greater than or equal to 300,000 and less than or equal to 1,200,000.

The thickness of the resin layer 80 may be less than or equal to 100 μm or may be 80 μm from the viewpoint of the passage of the metal ions. The lower limit of the thickness of the resin layer 80 is not particularly limited and may be 0.1 μm or may be 1.0 μm. In the specification, the thickness of the resin layer 80 means the distance R1 from a surface of the resin layer 80 that is exposed outside to the first surface 70a of the porous layer 70 that is in contact with the resin layer 80. The thickness of the resin layer 80 can be determined by, for example, a method below. First, a cross section of the metal ion-conducting membrane 30 is observed with a scanning electron microscope. The above-mentioned distance R1 is measured at a plurality of arbitrary points (for example, five points) using the obtained electron micrograph. The average of the obtained values can be regarded as the thickness of the resin layer 80.

The resin layer 80 is swollen by at least one selected from the group consisting of the first liquid 12 and the second liquid 22 and allows the metal ions to pass therethrough. The term “swell” as used herein means that the resin layer 80 absorbs a portion of the first nonaqueous solvent contained in the first liquid 12 or the second nonaqueous solvent contained in the second liquid 22, and therefore the volume or weight of the resin layer 80 increases. When the resin layer 80 is swollen, a space between two neighboring molecules of the polymer is enlarged in the resin layer 80. In the swollen resin layer 80, the size of the space between the two neighboring polymer molecules is, for example, greater than the size of the metal ions and less than the size of the first redox species 18 solvated with the first nonaqueous solvent. In this case, the passage of the metal ions through the resin layer 80 can be ensured, and a crossover that the first redox species moves to the second liquid can be suppressed.

The porous layer 70 includes a porous body 71. The shape of the porous body 71 is, for example, a plate shape. The porous body 71 may or may not be a nonwoven fabric. A plurality of pores 72 contained in the porous body 71 may be each open to the first surface 70a and second surface 70b of the porous layer 70. In the porous body 71, at least one of the pores 72 may be connected to another one of the pores 72. The pores 72 may be three-dimensionally continuous. Incidentally, the pores 72 may be independent of each other. The pores 72 may include a plurality of continuous pores and a plurality of independent pores. Each of the pores 72 may be a through-pore extending through the porous body 71 in a thickness direction thereof.

The porous body 71 contains, for example, porous glass. The porous body 71 may contain porous glass as a major component or may consist essentially of porous glass. Incidentally, the porous body 71 may contain an impurity in addition to porous glass.

The composition of the porous glass is not particularly limited unless the porous glass is soluble in the first liquid 12 and the second liquid 22 and is reactive with the first liquid 12 or the second liquid 22. The porous glass may contain silica, titanic, zirconia, yttria, ceria, lanthanum oxide, or the like and may contain silica as a major component. When the porous glass contains silica as a major component, the porous glass is almost unreactive with the first liquid 12 even in a case where the first liquid 12 exhibits a very low potential of less than or equal to 0.5 V vs. Li⁺/Li and has high reducing power. The content of silica in the porous glass may be greater than or equal to 50% by weight. The porous glass may consist essentially of silica.

The total pore volume of the porous body 71 is not particularly limited and may be greater than or equal to 0.05 mL/g and less than or equal to 0.5 mL/g. The total pore volume of the porous body 71 is obtained in such a manner that, for example, data on an adsorption isotherm obtained by a gas adsorption method using a nitrogen gas is converted by the Barrett-Joyner-Halenda (BJH) technique. The specific surface area of the porous body 71 is not particularly limited and may be greater than or equal to 15 m²/g and less than or equal to 3,600 m²/g or may be greater than or equal to 200 m²/g and less than or equal to 500 m²/g. The specific surface area of the porous body 71 is obtained in such a manner that, for example, data on an adsorption isotherm obtained by a gas adsorption method using a nitrogen gas is converted by the Brunauer-Emmett-Teller (BET) method. Data on an adsorption isotherm may be obtained by a gas adsorption method using an argon gas.

The average pore size of the porous body 71 may be less than or equal to 50 nm, may be less than or equal to 15 nm, or may be less than or equal to 4 nm. The average pore size of the porous body 71 may be greater than or equal to 1 nm or may be greater than or equal to 2 nm. When the porous body 71 contains the porous glass, the average pore size of the porous body 71 can be readily controlled by appropriately adjusting the composition ratio of raw materials used to produce the porous glass, heat treatment conditions, or the like. Therefore, the porous body 71 can be readily prepared so as to have a narrow pore size distribution and an average pore size of less than or equal to 50 nm. The average pore size d of the porous body 71 can be calculated by substituting the specific surface area a and total pore volume v of the porous body 71 into an equation below. When all pores contained in the porous body 71 are regarded as a single cylindrical pore, the average pore size d corresponds to the diameter of the cylindrical pore.

Average pore size d=4×total pore volume v/specific surface area a

The average pore size of the porous body 71 may be measured by a method such as a mercury intrusion method, direct observation with an electron microscope, or a positron annihilation method.

The average pore size of the porous body 71 is larger than, for example, the size of the metal ions and is smaller than the size of the first redox species 18 solvated with the first nonaqueous solvent. In this case, the passage of the metal ions through the metal ion-conducting membrane 30 can be ensured and a crossover that the first redox species 18 moves to the second liquid 22 can be sufficiently suppressed. Suppressing the crossover of the first redox species 18 to the second liquid 22 enables the concentration of the first redox species 18 in the first liquid 12 to be maintained. Therefore, the charge/discharge capacity of the redox flow battery 100 can be maintained over a long period of time.

In the redox flow battery 100 according to the present embodiment, the metal ions include, for example, at least one selected from the group consisting of lithium ions, sodium ions, magnesium ions, and aluminium ions. The size of the metal ions varies depending on coordination with a solvent or another ion species. In the specification, the size of the metal ions means, for example, the diameter of the metal ions. For example, the diameter of a lithium ion is greater than or equal to 0.12 nm and less than or equal to 0.18 nm. The diameter of a sodium ion is greater than or equal to 0.20 nm and less than or equal to 0.28 nm. The diameter of a magnesium ion is greater than or equal to 0.11 nm and less than or equal to 0.18 nm. The diameter of an aluminium ion is greater than or equal to 0.08 nm and less than or equal to 0.11 nm. The size of the solvated metal ions varies depending on the type of a solvent, coordination with the solvent, or the like and is less than or equal to, for example, 1 nm. Therefore, when the average pore size of the porous body 71 is greater than 2 nm, the passage of the solvated metal ions can be sufficiently ensured.

In the redox flow battery 100 according to the present embodiment, the first redox species 18 is, for example, an aromatic compound as described below. The size of the first redox species 18 itself and the size of the first redox species 18 solvated with the first nonaqueous solvent can be calculated by, for example, first-principles calculation using the density functional method B3LYP/6-31G. In the specification, the size of the first redox species 18 solvated with the first nonaqueous solvent means, for example, the diameter of the minimum sphere that can enclose the first redox species 18 solvated with the first nonaqueous solvent. The size of the first redox species 18 itself is greater than or equal to, for example, about 1 nm. The size of the first redox species 18 solvated with the first nonaqueous solvent varies depending on the type of the first nonaqueous solvent, the coordination state of the first nonaqueous solvent, or the like. Supposing that, for example, the first nonaqueous solvent used is 2-methyltetrahydrofuran, the first redox species used is biphenyl, and a molecule of biphenyl is solvated with 100 molecules of 2-methyltetrahydrofuran, the size of solvated biphenyl is calculated to be about 4 nm. Therefore, when the average pore size of the porous body 71 is less than or equal to 4 nm, the passage of solvated biphenyl can be sufficiently suppressed. Incidentally, the size of a molecule of 2-methyltetrahydrofuran is about 0.7 nm. Supposing that a molecule of biphenyl is solvated with some molecules of 2-methyltetrahydrofuran, the size of solvated biphenyl is calculated to be about 2.4 nm. Therefore, when the average pore size of the porous body 71 is less than or equal to 2.4 nm, the passage of solvated biphenyl can be further suppressed. The coordination state and coordination number of the first nonaqueous solvent for the first redox species 18 can be estimated from, for example, results of the NMR measurement of the first liquid 12. As described above, the average pore size of the porous body 71 can be adjusted depending on the size of the metal ions, the type of the first redox species 18, the coordination number of the first nonaqueous solvent, the type of the first nonaqueous solvent that has an influence on the coordination number thereof, or the like.

As long as the metal ion-conducting membrane 30 has sufficient permeability for the metal ions with respect to the operation of the redox flow battery 100 and the mechanical strength of the metal ion-conducting membrane 30 can be ensured, the porosity of the porous body 71 is not particularly limited. The porosity of the porous body 71 may be, for example, greater than or equal to 20% and less than or equal to 50%. The porosity of the porous body 71 can be measured by, for example, a method below. First, the volume V and weight W of the porous body 71 are measured. The porosity thereof can be calculated in such a manner that the obtained volume V, the obtained weight W, and the density D of the material of the porous body 71 are substituted into the following equation:

Porosity(%)=100×(V−(W/D))/V.

The porous layer 70 further includes a filler 73. The filler 73 is located in the pores 72 of the porous body 71. In particular, the filler 73 fills an inner portion of each of the pores 72 of the porous body 71. The filler 73 may partly fill the inner portion of each of the pores 72 of the porous body 71 or may fill the whole of the inner portion of each of the pores 72. For example, when T is defined as the thickness of the porous layer 70, the filler 73 fills the inner portion of each of the pores 72 in a range from the first surface 70a, which is in contact with the resin layer 80, to T/3. The filler 73 is, for example, nonporous and has a dense surface.

The filler 73 contains a fluorocarbon resin. The filler 73 may contain the fluorocarbon resin as a major component or may consist essentially of the fluorocarbon resin. The fluorocarbon resin contained in the filler 73 contains a polymer that is at least one selected from the group consisting of PVDF and polyvinyl fluoride. The fluorocarbon resin contained in the filler 73 may contain PVDF as a major component or may consist essentially of PVDF. The fluorocarbon resin contained in the filler 73 is the same as, for example, the fluorocarbon resin contained in the resin layer 80. The filler 73 and the resin layer 80 have, for example, the same composition.

As described above, the metal ion-conducting membrane 30 contains the fluorocarbon resin contained in the filler 73 and the fluorocarbon resin contained in the resin layer 80. The content of all the fluorocarbon resins in the metal ion-conducting membrane 30 is, for example, greater than or equal to 16% by weight and less than or equal to 44% by weight.

As long as the metal ion-conducting membrane 30 has sufficient permeability for the metal ions with respect to the operation of the redox flow battery 100 and the mechanical strength of the metal ion-conducting membrane 30 can be ensured, the thickness of the porous layer 70 is not particularly limited. The thickness of the porous layer 70 may be greater than or equal to 0.2 mm and less than or equal to 1.0 mm or may be less than or equal to 0.5 mm. In the specification, the thickness of the porous layer 70 means the distance R2 from the first surface 70a to second surface 70b of the porous layer 70. The thickness of the porous layer 70 can be determined by, for example, a method below, First, a cross section of the metal ion-conducting membrane 30 is observed with a scanning electron microscope. The above-mentioned distance R2 is measured at a plurality of arbitrary points (for example, five points) using the obtained electron micrograph. The average of the obtained values can be regarded as the thickness of the porous layer 70.

FIG. 3 is an illustration showing a method for manufacturing the metal ion-conducting membrane 30. The method for manufacturing the metal ion-conducting membrane 30 is not particularly limited. The metal ion-conducting membrane 30 can be prepared by, for example, a method below. First, a layer 75 including the porous body 71 is prepared. The layer 75 has a first surface 75a and second surface 75b opposite to each other. The layer 75 may consist essentially of the porous body 71. When the porous body 71 contains the porous glass, the porous glass can be prepared using phase separation. A method for preparing the porous glass using phase separation is described below. First, two or more types of glass raw materials are melted and are mixed together, whereby a glass composition is obtained. The glass raw materials may include silica and boric acid. The glass composition may be borosilicate glass. The glass composition may be subjected to molding treatment. Next, the glass composition is heat-treated, whereby the glass composition is phase-separated. The phase-separated glass composition contains a plurality of phases having compositions different from each other. The phase-separated glass composition contains, for example, a phase containing silica and a phase containing boron oxide. Next, one of the phases contained in the glass composition is removed by acid treatment. For example, the phase containing boron oxide is removed by acid treatment. This allows the porous glass, which has a plurality of pores, to be obtained.

Next, a fluorocarbon resin is dissolved in an organic solvent such as N-methylpyrrolidone, whereby a solution containing the fluorocarbon resin is prepared. Next, the solution is applied to the first surface 75a of the layer 75, whereby a coating 85 is formed. A known coating device such as an applicator or a bar coater can be used to apply the solution. Next, the inner portions of the pores 72 of the porous body 71 are filled with the solution containing the fluorocarbon resin. The inner portions of the pores 72 of the porous body 71 are filled with the solution containing the fluorocarbon resin in such a manner that, for example, a pressure difference is created between a first space 90 adjacent to the coating 85 and a second space 91 adjacent to the second surface 75b of the layer 75. The pressure difference is, for example, greater than or equal to 90 kPa and less than or equal to 99 kPa.

The pressure difference can be created by, for example, a method below. First, a laminate of the coating 85 and the layer 75 is set to a suction filter 95 such that the second space 91, which is adjacent to the second surface 75b of the layer 75, coincides with a space inside the suction filter 95. After the layer 75 is set to the suction filter 95 instead of the laminate, the coating 85 may be formed. The suction filter 95 is provided with a decompression device (not shown) such as a vacuum pump. Next, the space inside the suction filter 95 is decompressed with the decompression device. This enables a pressure difference to be created between the first space 90 and the second space 91. In this operation, the pressure in the first space 90 is relatively higher than the pressure in the second space 91, and therefore the inner portions of the pores 72 of the porous body 71 are filled with the solution, containing the fluorocarbon resin, that forms the coating 85. In particular, the inner portion of each of the pores 72 of the porous body 71 is filled with the solution containing the fluorocarbon resin. The inner portion of each of the pores 72 of the porous body 71 may be partly filled with the solution containing the fluorocarbon resin, or the whole of the inner portion of each of the pores 72 may be filled with the solution containing the fluorocarbon resin.

As long as the pressure in the first space 90 can be set relatively higher than the pressure in the second space 91, a method for creating the pressure difference is not particularly limited. The pressure difference may be created in such a manner that, for example, the first space 90, which is adjacent to the coating 85, is compressed instead of decompressing the second space 91, which is adjacent to the second surface 75b of the layer 75.

The pressure difference need not be created in some cases, depending on the average pore size of the porous body 71, the viscosity of the solution containing the fluorocarbon resin, or the like. For example, in some cases, allowing the coating 85 and the layer 75 to stand in such a state that the coating 85 is located above the layer 75 enables the inner portions of the pores 72 of the porous body 71 to be filled with the solution containing the fluorocarbon resin by the self-weight of the solution, containing the fluorocarbon resin, that forms the coating 85.

In the manufacturing method according to the present embodiment, the coating 85 is dried after filling the inner portions of the pores 72 with the solution containing the fluorocarbon resin or concurrently with filling the inner portions of the pores 72 with the solution containing the fluorocarbon resin. This forms the porous layer 70 and the resin layer 80, thereby enabling the metal ion-conducting membrane 30 to be obtained. Drying conditions of the coating 85 are not particularly limited. The coating 85 may be naturally dried at room temperature or may be dried using a vacuum dryer.

In the manufacturing method according to the present embodiment, before the resin layer 80 is formed, the organic solvent contained in the coating 85 may be replaced with water. This enables the coating 85 to be phase-separated. A method for replacing the organic solvent contained in the coating 85 with water is not particularly limited. The organic solvent contained in the coating 85 can be replaced with water in such a manner that, for example, the coating 85 and the layer 75 are immersed in water. The resin layer 80 can be obtained by drying the phase-separated coating 85 so as to be porous. The average pore size of the resin layer 80 can be appropriately adjusted depending on the weight-average molecular weight of the polymer contained in the fluorocarbon resin, conditions for phase-separating the coating 85, drying conditions of the coating 85, or the like.

In the redox flow battery 100, the first liquid 12 functions as an electrolytic solution. The first nonaqueous solvent, which is contained in the first liquid 12, includes, for example, a compound containing a carbonate group and/or an ether bond. The first nonaqueous solvent may include at least one selected from the group consisting of propylene carbonate (PC), ethylene carbonate (EC), dimethyl carbonate (DMC), ethyl methyl carbonate (EMC), and diethyl carbonate (DEC) as a carbonate group-containing compound. The first nonaqueous solvent may include at least one selected from the group consisting of dimethoxyethane, diethoxyethane, dibutoxyethane, diglyme (diethylene glycol dimethyl ether), triglyme (triethylene glycol dimethyl ether), tetraglyme (tetraethylene glycol dimethyl ether), polyethylene glycol dialkyl ethers, tetrahydrofuran, 2-methyltetrahydrofuran, 2,5-dimethyltetrahydrofuran, 1,3-dioxolane, and 4-methyl-1,3-dioxolane as an ether bond-containing compound.

The first redox species 18, which is contained in the first liquid 12, can be dissolved in the first liquid 12. The first redox species 18 is electrochemically oxidized or reduced by the negative electrode 10 and is electrochemically oxidized or reduced by the negative electrode active material 14. In other words, the first redox species 18 functions as a negative electrode mediator. When the redox flow battery 100 includes no negative electrode active material 14, the first redox species 18 functions as an active material that is oxidized or reduced by the negative electrode 10 only.

The first redox species 18 includes, for example, an organic compound that dissolves lithium as cations. The organic compound may be an aromatic compound or a condensed aromatic compound. The first redox species 18 includes, for example, at least one selected from the group consisting of biphenyl, phenanthrene, trans-stilbene, cis-stilbene, triphenylene, o-terphenyl, m-terphenyl, p-terphenyl, anthracene, benzophenone, acetophenone, butyrophenone, valerophenone, acenaphthene, acenaphthylene, fluoranthene, and benzil as an aromatic compound. The molecular weight of the first redox species 18 is not particularly limited and may be greater than or equal to 100 and less than or equal to 500 or may be greater than or equal to 100 and less than or equal to 300.

When the first redox species 18 used is the aromatic compound and lithium is dissolved in the first liquid 12, the first liquid 12 exhibits a very low potential of less than or equal to 0.5 V vs. Li⁺/Li in some cases. Combining the first liquid 12 with a second liquid 22 which exhibits a potential of greater than or equal to 2.5 V vs. Li⁺/Li allows the redox flow battery 100 to exhibit a battery voltage of greater than or equal to 3.0 V. This allows the redox flow battery 100 to have high energy density. In this case, the first liquid 12 has very high reducing power. From the viewpoint of sufficiently ensuring durability against the first liquid 12, porous glass containing silica as a major component is suitable for material of the porous body 71, which is included in the metal ion-conducting membrane 30.

As described above, the metal ions, which are contained in the first liquid 12, include, for example, at least one selected from the group consisting of lithium ions, sodium ions, magnesium ions, and aluminium ions. The metal ions are, for example, lithium ions.

The first liquid 12 may further contain an electrolyte. The electrolyte is, for example, at least one selected from the group consisting of LiBF₄, LiPF₆, lithium bis(trifluoromethanesulfonyl)imide (LiTFSI), lithium bis(fluorosulfonyl)imide (LiFSI), LiCF₃SO₃, LiCIO₄, NaBF₄, NaPF₆, NaTFSI, NaFSI, NaCF₃SO₃, NaClO₄, Mg(BF₄)₂, Mg(PF₆)₂, Mg(TFSI)₂; Mg(FSI)₂, Mg(CF₃SO₃)₂, Mg(ClO₄)₂, AlCl₃, AlBr₃, and Al(TFSI)₃. The first liquid 12 may have a high dielectric constant and may further have a potential window of less than or equal to about 4 V depending on the electrolyte.

The negative electrode 10 has, for example, a surface acting as a reaction field for the first redox species 18. The material of the negative electrode 10 is stable to, for example, the first liquid 12. The material of the negative electrode 10 may be insoluble in the first liquid 12. The material of the negative electrode 10 is also stable to, for example, an electrochemical reaction which is an electrode reaction. The material of the negative electrode 10 may be metal, carbon, or the like. Examples of metal used as the material of the negative electrode 10 include stainless steel, iron, copper, and nickel.

The negative electrode 10 may have a structure with an increased surface area. Examples of such a structure with an increased surface area include meshes, nonwoven fabrics, surface-roughened plates, and sintered porous bodies. When the negative electrode 10 has such a structure, the negative electrode 10 has a large specific surface area. Therefore, the oxidation reaction or reduction reaction of the first redox species 18 in the negative electrode 10 proceeds readily.

In the redox flow battery 100, at least a portion of the negative electrode active material 14 is in contact with the first liquid 12. The negative electrode active material 14 is insoluble in, for example, the first liquid 12. The negative electrode active material 14 can reversibly store or release the metal ions. The material of the negative electrode active material 14 may be metal, a metal oxide, carbon, silicon, or the like. The metal may be lithium, sodium, magnesium, aluminium, tin, or the like. The metal oxide may be titanium oxide or the like. When the first redox species 18 is the aromatic compound and lithium is dissolved in the first liquid 12, the negative electrode active material 14 may contain at least one selected from the group consisting of carbon, silicon, aluminium, and tin.

The shape of the negative electrode active material 14 is not particularly limited and the negative electrode active material 14 may be granular, powdery, or pellet-shaped. The negative electrode active material 14 may be bound with a binder. Examples of the binder include resins such as polyvinylidene fluoride, polypropylene, polyethylene, and polyimide.

When the redox flow battery 100 includes the negative electrode active material 14, the charge/discharge capacity of the redox flow battery 100 does not depend on the solubility of the first redox species 18 but depends on the capacity of the negative electrode active material 14. Therefore, the redox flow battery 100 can be readily achieved so as to have high energy density.

In the redox flow battery 100, the second liquid 22 functions as an electrolytic solution. The second nonaqueous solvent includes, for example, a compound containing a carbonate group and/or an ether bond. Examples of the compound containing the carbonate group and/or the ether bond include the compounds exemplified for the first nonaqueous solvent. The second nonaqueous solvent may be the same as or different from the first nonaqueous solvent.

The second liquid 22 may further contain a second redox species 28. In this case, the redox flow battery 100 may further include a positive electrode active material 24 in contact with the second liquid 22. When the redox flow battery 100 includes the positive electrode active material 24, the second redox species 28 functions as a positive electrode mediator. The second redox species 28 is dissolved in, for example, the second liquid 22. The second redox species 28 is oxidized or reduced by the positive electrode 20 and is oxidized or reduced by the positive electrode active material 24. When the redox flow battery 100 includes no positive electrode active material 24, the second redox species 28 functions as an active material that is oxidized or reduced by the positive electrode 20 only.

The second redox species 28 includes, for example, at least one selected from the group consisting of tetrathiafulvalene, triphenylamine, and derivatives thereof. Examples of the derivatives of triphenylamine include 4,4-dimethyltriphenylamine and bis(4-formylphenyl)phenylamine. The second redox species 28 may be, for example, a metallocene compound such as ferrocene or titanocene. The second redox species 28 may be a heterocyclic compound such as a bipyridyl derivative, a thiophene derivative, a thianthrene derivative, a carbazole derivative, or a phenanthroline derivative. The second redox species 28 used may be a combination of two or more of these derivatives as required.

In the metal ion-conducting membrane 30, the average pore size of the porous body 71 is less than, for example, the size of the second redox species 28 solvated with the second nonaqueous solvent. In this case, a crossover that the second redox species 28 moves to the first liquid 12 can be sufficiently suppressed. The average pore size of the porous body 71 is less than, for example, the minimum one of the size of the first redox species 18 solvated with the first nonaqueous solvent and the size of the second redox species 28 solvated with the second nonaqueous solvent.

The size of the second redox species 28 solvated with the second nonaqueous solvent can be calculated by, for example, first-principles calculation using the density functional method B3LYP/6-31G as is the case with the first redox species 18. In the specification, the size of the second redox species 28 solvated with the second nonaqueous solvent means, for example, the diameter of the minimum sphere that can enclose the second redox species 28 solvated with the second nonaqueous solvent. The coordination state and coordination number of the second nonaqueous solvent for the second redox species 28 can be estimated from, for example, results of the NMR measurement of the second liquid 22.

In the redox flow battery 100 according to the present embodiment, the range of options for the first liquid 12, the first redox species 18, the second liquid 22, and the second redox species 28 is wide. Therefore, the control range of the charge potential and discharge potential of the redox flow battery 100 is wide, and the charge capacity of the redox flow battery 100 can be readily increased. Furthermore, the first liquid 12 and the second liquid 22 are hardly mixed due to the metal ion-conducting membrane 30. Therefore, charge/discharge characteristics of the redox flow battery 100 can be maintained over a long period of time.

The positive electrode 20 has, for example, a surface acting as a reaction field for the second redox species 28. The material of the positive electrode 20 is stable to, for example, the second liquid 22. The material of the positive electrode 20 may be insoluble in the second liquid 22. The material of the positive electrode 20 is also stable to, for example, an electrochemical reaction. The material of the positive electrode 20 may be the material exemplified for the negative electrode 10. The material of the positive electrode 20 may be the same as or different from the material of the negative electrode 10.

The positive electrode 20 may have a structure with an increased surface area. Examples of such a structure with an increased surface area include meshes, nonwoven fabrics, surface-roughened plates, and sintered porous bodies. When the positive electrode 20 has such a structure, the positive electrode 20 has a large specific surface area. Therefore, the oxidation or reduction reaction of the second redox species 28 in the positive electrode 20 proceeds readily.

When the second liquid 22 contains the second redox species 28, the redox flow battery 100 may further include the positive electrode active material 24 as described above. At least a portion of the positive electrode active material 24 is in contact with the second liquid 22. The positive electrode active material 24 is insoluble in, for example, the second liquid 22, The positive electrode active material 24 can reversibly store or release the metal ions. Examples of the positive electrode active material 24 include metal oxides such as lithium iron phosphate, LiCoO₂ (LCO), LiMn₂O₄ (LMO), and lithium-nickel-cobalt-aluminium composite oxide (NCA).

The shape of the positive electrode active material 24 is not particularly limited and the positive electrode active material 24 may be granular, powdery, or pellet-shaped. The positive electrode active material 24 may be bound with a binder. Examples of the binder include resins such as polyvinylidene fluoride, polypropylene, polyethylene, and polyimide.

When the redox flow battery 100 includes the negative electrode active material 14 and the positive electrode active material 24, the charge/discharge capacity of the redox flow battery 100 does not depend on the solubility of the first redox species 18 or the second redox species 28 but depends on the capacity of the negative electrode active material 14 and the positive electrode active material Therefore, the redox flow battery 100 can be readily achieved so as to have high energy density.

The redox flow battery 100 may further include an electrochemical reaction section 60, a negative electrode terminal 16, and a positive electrode terminal 26. The electrochemical reaction section 60 includes a negative electrode compartment 61 and a positive electrode compartment 62. The metal ion-conducting membrane 30 is disposed in the electrochemical reaction section 60. In the inside of the electrochemical reaction section 60, the metal ion-conducting membrane 30 separates the negative electrode compartment 61 from the positive electrode compartment 62.

The negative electrode compartment 61 contains the negative electrode 10 and the first liquid 12. In the inside of the negative electrode compartment 61, the negative electrode 10 is in contact with the first liquid 12. The positive electrode compartment 62 contains the positive electrode 20 and the second liquid 22. In the inside of the positive electrode compartment 62, the positive electrode 20 is in contact with the second liquid 22.

The negative electrode terminal 16 is electrically connected to the negative electrode 10. The positive electrode terminal 26 is electrically connected to the positive electrode 20. The negative electrode terminal 16 and the positive electrode terminal 26 are electrically connected to, for example, a charge-discharge device. The charge-discharge device can apply a voltage to the redox flow battery 100 through the negative electrode terminal 16 and the positive electrode terminal 26. The charge-discharge device can draw electricity from the redox flow battery 100 through the negative electrode terminal 16 and the positive electrode terminal 26.

The redox flow battery 100 may further include a first circulation mechanism 40 and a second circulation mechanism 50. The first circulation mechanism 40 includes a first storage section 41, a first filter 42, a pipe 43, a pipe 44, and a pump 45. The first storage section 41 stores the negative electrode active material 14 and the first liquid 12. In the inside of the first storage section 41, the negative electrode active material 14 is in contact with the first liquid 12. For example, the first liquid 12 is present in a cavity in the negative electrode active material 14. The first storage section 41 is, for example, a tank.

The first filter 42 is disposed at an outlet of the first storage section 41. The first filter 42 may be disposed at an inlet of the first storage section 41 or may be disposed at an inlet or outlet of the negative electrode compartment 61. The first filter 42 may be disposed in the pipe 43 as described below. The first filter 42 allows the first liquid 12 to pass therethrough and suppresses the passage of the negative electrode active material 14. When the negative electrode active material 14 is granular, the first filter 42 has, for example, pores smaller than the particle size of the negative electrode active material 14. The material of the first filter 42 is not particularly limited as long as the material is almost unreactive with the negative electrode active material 14 or the first liquid 12. Examples of the first filter 42 include glass fiber filter paper, polypropylene nonwoven fabrics, polyethylene nonwoven fabrics, polyethylene separators, polypropylene separators, polyimide separators, separators with a polyethylene/polypropylene two-layer structure, separators with a polypropylene/polyethylene/polypropylene three-layer structure, and metal meshes unreactive with metallic lithium. According to the first filter 42, the leakage of the negative electrode active material 14 from the first storage section 41 can be suppressed. This allows the negative electrode active material 14 to remain in the first storage section 41. In the redox flow battery 100, the negative electrode active material 14 itself does not circulate. Therefore, the inside of the pipe 43 or the like is unlikely to be clogged with the negative electrode active material 14. According to the first filter 42, the occurrence of resistance loss due to the leakage of the negative electrode active material 14 into the negative electrode compartment 61 can also be suppressed.

The pipe 43 is connected to, for example, the outlet of the first storage section 41 with the first filter 42 therebetween. The pipe 43 has an end connected to the outlet of the first storage section 41 and another end connected to the inlet of the negative electrode compartment 61. The first liquid 12 is fed to the negative electrode compartment 61 from the first storage section 41 through the pipe 43.

The pipe 44 has an end connected to the outlet of the negative electrode compartment 61 and another end connected to the inlet of the first storage section 41. The first liquid 12 is fed to the first storage section 41 from the negative electrode compartment 61 through the pipe 44.

The pump 45 is disposed in the pipe 44. The pump 45 may be disposed in the pipe 43. The pump 45 pressurizes, for example, the first liquid 12. The flow rate of the first liquid 12 can be regulated by controlling the pump 45. The circulation of the first liquid 12 can be started or stopped with the pump 45. Incidentally, the flow rate of the first liquid 12 can be regulated with a member other than a pump. The member is, for example, a valve.

As described above, the first circulation mechanism 40 can circulate the first liquid 12 between the negative electrode compartment 61 and the first storage section 41. According to the first circulation mechanism 40, the amount of the first liquid 12 in contact with the negative electrode active material 14 can be readily increased. The contact time between the first liquid 12 and the negative electrode active material 14 can also be increased. Therefore, the oxidation reaction and reduction reaction of the first redox species 18 with the negative electrode active material 14 can be efficiently carried out.

The second circulation mechanism 50 includes a second storage section 51, a second filter 52, a pipe 53, a pipe 54, and a pump 55. The second storage section 51 stores the positive electrode active material 24 and the second liquid 22. In the inside of the second storage section 51, the positive electrode active material 24 is in contact with the second liquid 22. For example, the second liquid 22 is present in a cavity in the positive electrode active material 24. The second storage section 51 is, for example, a tank.

The second filter 52 is disposed at an outlet of the second storage section 51. The second filter 52 may be disposed at an inlet of the second storage section 51 or may be disposed at an inlet or outlet of the positive electrode compartment 62. The second filter 52 may be disposed in the pipe 53 as described below. The second filter 52 allows the second liquid 22 to pass therethrough and suppresses the passage of the positive electrode active material 24. When the positive electrode active material 24 is granular, the second filter 52 has, for example, pores smaller than the particle size of the positive electrode active material 24. The material of the second filter 52 is not particularly limited as long as the material is almost unreactive with the positive electrode active material 24 or the second liquid 22. Examples of the second filter 52 include glass fiber filter paper, polypropylene nonwoven fabrics, polyethylene nonwoven fabrics, and metal meshes unreactive with metallic lithium. According to the second filter 52, the leakage of the positive electrode active material 24 from the second storage section 51 can be suppressed. This allows the positive electrode active material 24 to remain in the second storage section 51. In the redox flow battery 100, the positive electrode active material 24 itself does not circulate. Therefore, the inside of the pipe 53 or the like is unlikely to be clogged with the positive electrode active material 24. According to the second filter 52, the occurrence of resistance loss due to the leakage of the positive electrode active material 24 into the positive electrode compartment 62 can also be suppressed.

The pipe 53 is connected to, for example, the outlet of the second storage section 51 with the second filter 52 therebetween. The pipe 53 has an end connected to the outlet of the second storage section 51 and another end connected to the inlet of the positive electrode compartment 62. The second liquid 22 is fed to the positive electrode compartment 62 from the second storage section 51 through the pipe 53.

The pipe 54 has an end connected to the outlet of the positive electrode compartment 62 and another end connected to the inlet of the second storage section 51. The second liquid 22 is fed to the second storage section 51 from the positive electrode compartment 62 through the pipe 54.

The pump 55 is disposed in the pipe 54. The pump 55 may be disposed in the pipe 53. The pump 55 pressurizes, for example, the second liquid 22. The flow rate of the second liquid 22 can be regulated by controlling the pump 55. The circulation of the second liquid 22 can be started or stopped with the pump 55. Incidentally, the flow rate of the second liquid 22 can be regulated with a member other than a pump. The member is, for example, a valve.

As described above, the second circulation mechanism 50 can circulate the second liquid 22 between the positive electrode compartment 62 and the second storage section 51. According to the second circulation mechanism 50, the amount of the second liquid 22 in contact with the positive electrode active material 24 can be readily increased. The contact time between the second liquid 22 and the positive electrode active material 24 can also be increased. Therefore, the oxidation reaction and reduction reaction of the second redox species 28 with the positive electrode active material 24 can be efficiently carried out.

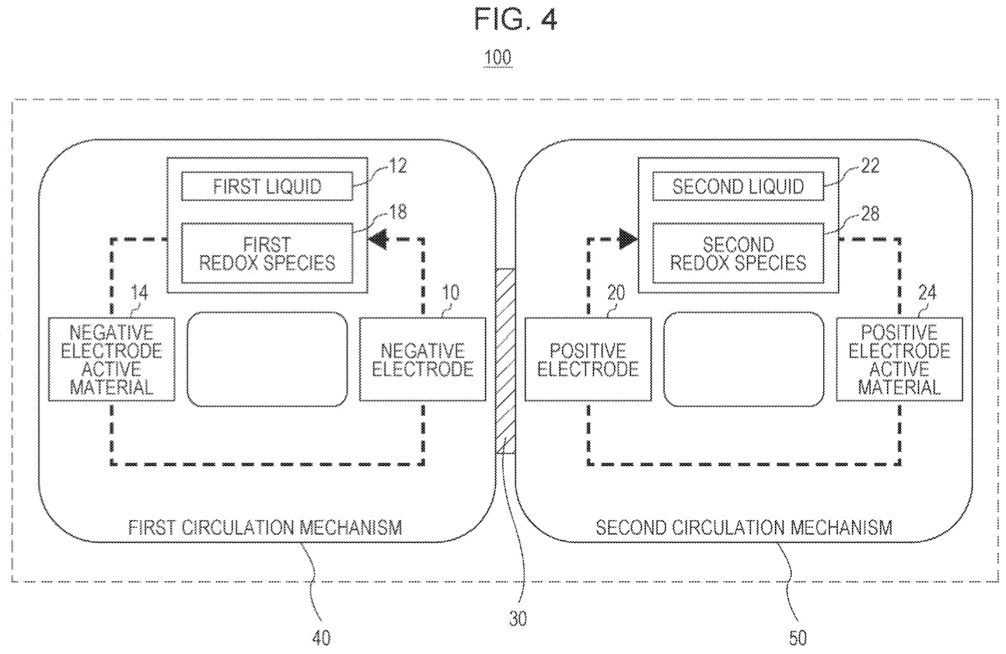

Next, an example of the operation of the redox flow battery 100 is described with reference to FIG. 4. FIG. 4 is an illustration showing the operation of the redox flow battery 100 shown in FIG. 1. In the description below, the first redox species 18 is referred to as “Md” in some cases. The negative electrode active material 14 is referred to as “NA” in some cases. In the description below, the second redox species 28 used is tetrathiafulvalene (hereinafter referred to as “TTF” in some cases). The positive electrode active material 24 used is lithium iron phosphate (LiFePO₄). In the description below, the metal ions are lithium ions.

### Charge Process of Redox Flow Battery

First, a voltage is applied between the negative electrode 10 and positive electrode 20 of the redox flow battery 100, whereby the redox flow battery 100 is charged. Reactions on the negative electrode 10 side and reactions on the positive electrode 20 side in a charge process are described below.

### Reactions on Negative Electrode Side

Electrons are supplied to the negative electrode 10 from outside the redox flow battery 100 by the application of voltage. This allows the first redox species 18 to be reduced on a surface of the negative electrode 10. The reduction reaction of the first redox species 18 is represented by, for example, a reaction equation below. Incidentally, lithium ions (Li⁺) are supplied from, for example, the second liquid 22 through the metal ion-conducting membrane 30.

Md+Li⁺+e⁻→Md.Li

In the above reaction equation, Md.Li is a composite of a lithium cation and the reduced first redox species 18. The reduced first redox species 18 contains an electron solvated with the solvent in the first liquid 12. As the reduction reaction of the first redox species 18 proceeds, the concentration of Md.Li in the first liquid 12 increases. The increase in the concentration of Md.Li in the first liquid 12 reduces the potential of the first liquid 12. The potential of the first liquid 12 is reduced to a value less than the maximum potential at which the negative electrode active material 14 can store lithium ions.

Next, Md.Li is fed to the negative electrode active material 14 by the first circulation mechanism 40. The potential of the first liquid 12 is lower than the maximum potential at which the negative electrode active material 14 can store lithium ions, Therefore, the negative electrode active material 14 receives a lithium ion and an electron from Md.Li. This oxidizes the first redox species 18 and reduces the negative electrode active material 14. This reaction is represented by, for example, a reaction equation below. Incidentally, in the reaction equation below, s and t are an integer of 1 or more.

sNA+tMd.Li→NAₛLiₜ+tMd

In the above reaction equation, NAₛLiₜ is a lithium compound formed as the negative electrode active material 14 stores lithium ions. When the negative electrode active material 14 contains graphite, s and tin the above reaction equation are, for example, 6 and 1, respectively. In this case, NAₛLiₜ is C₆Li. When the negative electrode active material 14 contains aluminium, tin, or silicon, s and tin the above reaction equation are, for example, 1. In this case, NAₛLiₜ is LiAl, LiSn, or LiSi.

Next, the first redox species 18 oxidized by the negative electrode active material 14 is fed to the negative electrode 10 by the first circulation mechanism 40. The first redox species 18 fed to the negative electrode 10 is reduced on the surface of the negative electrode 10 again. This produces Md.Li. As described above, the negative electrode active material 14 is charged by the circulation of the first redox species 18. That is, the first redox species 18 functions as a charge mediator.

### Reactions on Positive Electrode Side

The second redox species 28 is oxidized on a surface of the positive electrode 20 by the application of voltage. This allows electrons to be drawn from the positive electrode 20 to outside the redox flow battery 100. The oxidation reaction of the second redox species 28 is represented by, for example, reaction equations below.

TTF→TTF+e⁻

TTF⁺→TTF²+e⁻

Next, the second redox species 28 oxidized on the positive electrode 20 is fed to the positive electrode active material 24 by the second circulation mechanism 50. The second redox species 28 fed to the positive electrode active material 24 is reduced by the positive electrode active material 24. On the other hand, the positive electrode active material 24 is oxidized by the second redox species 28. The positive electrode active material 24 oxidized by the second redox species 28 releases lithium ions. This reaction is represented by, for example, a reaction equation below.

LiFePO₄+TTF²⁺→FePO₄+Li⁺+TTF⁺

Next, the second redox species 28 reduced by the positive electrode active material 24 is fed to the positive electrode 20 by the second circulation mechanism 50. The second redox species 28 fed to the positive electrode 20 is oxidized on the surface of the positive electrode 20 again. This reaction is represented by, for example, a reaction equation below.

TTF→TTF²⁺e⁻

As described above, the positive electrode active material 24 is charged by the circulation of the second redox species 28. That is, the second redox species 28 functions as a charge mediator. Lithium ions (Li⁺) produced by the charge of the redox flow battery 100 move to, for example, the first liquid 12 through the metal ion-conducting membrane 30,

### Discharge Process of Redox Row Battery

In the charged redox flow battery 100, electricity can be drawn from the negative electrode 10 and the positive electrode 20. Reactions on the negative electrode 10 side and reactions on the positive electrode 20 side in a discharge process are described below.

### Reactions on Negative Electrode Side

The first redox species 18 is oxidized on the surface of the negative electrode 10 by the discharge of the redox flow battery 100. This allows electrons to be drawn from the negative electrode 10 to outside the redox flow battery 100. The oxidation reaction of the first redox species 18 is represented by, for example, a reaction equation below.

Md.Li→Md+Li⁺+e⁻

As the oxidation reaction of the first redox species 18 proceeds, the concentration of Md.Li in the first liquid 12 decreases. The decrease in the concentration of Md.Li in the first liquid 12 increases the potential of the first liquid 12. This allows the potential of the first liquid 12 to exceed the equilibrium potential of NAₛLiₜ.

Next, the first redox species 18 oxidized on the negative electrode 10 is fed to the negative electrode active material 14 by the first circulation mechanism 40. When the potential of the first liquid 12 is above the equilibrium potential of NAₛLiₜ, the first redox species 18 receives a lithium ion and an electron from NAₛLiₜ. This reduces the first redox species 18 and oxidizes the negative electrode active material 14. This reaction is represented by, for example, a reaction equation below. Incidentally, in the reaction equation below, s and t are an integer of 1 or more.

NAₛLiₜ+tMd→sNA+tMd.Li

Next, Md.Li is fed to the negative electrode 10 by the first circulation mechanism 40. Md.Li fed to the negative electrode 10 is oxidized on the surface of the negative electrode 10 again. As described above, the negative electrode active material 14 is discharged by the circulation of the first redox species 18. That is, the first redox species 18 functions as a discharge mediator. Lithium ions (Li⁺) produced by the discharge of the redox flow battery 100 move to, for example, the second liquid 22 through the metal ion-conducting membrane 30.

### Reactions on Positive Electrode Side

Electrons are supplied to the positive electrode 20 from outside the redox flow battery 100 by the discharge of the redox flow battery 100. This allows the second redox species 28 to be reduced on the surface of the positive electrode 20. The reduction reaction of the positive electrode 20 is represented by, for example, reaction equations below.

TTF²⁺+e⁻→TTF

TTF⁺+e⁻→TTF

Next, the second redox species 28 reduced on the positive electrode 20 is fed to the positive electrode active material 24 by the second circulation mechanism 50. The second redox species 28 fed to the positive electrode active material 24 is oxidized by the positive electrode active material 24. On the other hand, the positive electrode active material 24 is reduced by the second redox species 28. The positive electrode active material 24 reduced by the second redox species 28 stores lithium ions. This reaction is represented by, for example, a reaction equation below. Incidentally, lithium ions (Li⁺) are supplied from, for example, the first liquid 12 through the metal ion-conducting membrane 30.

FePO₄+Li⁺+TTF→LiFePO₄+TTF⁺

Next, the second redox species 28 oxidized by the positive electrode active material 24 is fed to the positive electrode 20 by the second circulation mechanism 50. The second redox species 28 fed to the positive electrode 20 is reduced on the surface of the positive electrode 20 again. This reaction is represented by, for example, a reaction equation below.

TTF⁺+e⁻→TTF

As described above, the positive electrode active material 24 is discharged by the circulation of the second redox species 28. That is, the second redox species 28 functions as a discharge mediator.

In the redox flow battery 100 according to the present embodiment, the resin layer 80 and the filler 73 included in the metal ion-conducting membrane 30 are swollen by the first liquid 12 or the second liquid 22. The metal ions, which include Li⁺ and the like, can pass through the resin layer 80 and the filler 73 through the first nonaqueous solvent or second nonaqueous solvent present in the swollen resin layer 80 and filler 73. Since the filler 73 is located in the pores 72 of the porous body 71, the filler 73 is unlikely to be swollen by the first liquid 12 and the second liquid 22 as compared to the resin layer 80. Therefore, the first redox species 18 and the second redox species 28 are dissolved in the first nonaqueous solvent or second nonaqueous solvent present in the filler 73 and hardly diffuse. This results in that the metal ion-conducting membrane 30 hardly allows the first redox species 18 and the second redox species 28 to pass therethrough. In particular, when the average pore size of the porous body 71 is less than the size of the first redox species 18 solvated with the first nonaqueous solvent and the size of the second redox species 28 solvated with the second nonaqueous solvent, the metal ion-conducting membrane 30 can further suppress the passage of the first redox species 18 and the second redox species 28. Suppressing a crossover that the first redox species 18 and the second redox species 28 move between the first liquid 12 and the second liquid 22 enables reactions of the first redox species 18 and the second redox species 28 to be suppressed. Suppressing the crossover enables the redox flow battery to exhibit high charge/discharge efficiency.

When the porous body 71 contains the porous glass, the porous body 71 is hardly swollen by the first liquid 12 or the second liquid 22. Therefore, the porous body 71 containing the porous glass is particularly suitable for suppressing the crossover of the first redox species 18 and the second redox species 28.

The mechanism of ion conduction in the metal ion-conducting membrane 30 is different from that in conventional ceramic solid electrolyte membranes. In the conventional ceramic solid electrolyte membranes, the ion conduction mechanism of a solid electrolyte is used. Therefore, when a solid electrolyte membrane is dense and has little electrolytic solution permeability, metal ions only pass through the solid electrolyte membrane and a crossover that an electrolytic solution and a solid electrolyte pass through the solid electrolyte membrane can be suppressed. On the other hand, the ion conductivity of the solid electrolyte membrane is low. Therefore, in the solid electrolyte membrane, it is difficult to achieve sufficiently low resistance in some cases. That is, in the solid electrolyte membrane, it is difficult to draw a current at a practical value in some cases. However, the metal ion-conducting membrane 30 according to the present embodiment allows metal ions that should be conducted to pass therethrough using the difference between the size of the metal ions that should be conducted and the size of the solvated first redox species 18 or second redox species 28. The metal ion-conducting membrane 30 itself hardly reduces the ion conductivity. Therefore, according to the metal ion-conducting membrane 30 of the present embodiment, an ion conductivity almost equal to the ion conductivity of an electrolytic solution itself can be achieved. That is, according to the metal ion-conducting membrane 30, a current can be drawn at a value sufficient for practical use.

In the case of using a ceramic electrolyte having metal ion conductivity as a separation membrane of a nonaqueous redox flow battery, large currents occur locally in the vicinity of grain boundaries and dendrites occur along the grain boundaries in some cases. Furthermore, the ion conductivity of the ceramic electrolyte itself is low. Therefore, it is difficult to charge or discharge the nonaqueous redox flow battery at high current density in some cases. However, when the porous body 71 of the metal ion-conducting membrane 30 is made of porous glass containing silica as a major component, glass forming the porous glass is amorphous and has few grain boundaries. Likewise, few grain boundaries are present in the resin layer 80 and the filler 73. Therefore, a locally large current hardly occurs during the operation of the redox flow battery 100. Therefore, a dendrite is unlikely to occur in the metal ion-conducting membrane 30. According to the metal ion-conducting membrane 30, the redox flow battery 100 can be charged or discharged at high current density.

### EXAMPLES

The present disclosure is further described below in detail with reference to examples. The present disclosure is not in any way limited to the examples. Many modifications can be made by those skilled in the art within the technical idea of the present disclosure.

### Example 1

### Configuration of Electrochemical Cell

First, a first redox species and an electrolyte salt were dissolved in a first nonaqueous solvent. The first redox species was biphenyl, the electrolyte salt was LiBF₄, and the first nonaqueous solvent was 2-methyltetrahydrofuran. The concentration of biphenyl in the obtained solution was 100 mmol/L. The concentration of LiBF₄ in the solution was 1 mol/L. Metallic lithium was dissolved in the solution up to a saturation, whereby first liquid was obtained.

Next, second redox species and an electrolyte salt were dissolved in a second nonaqueous solvent. The second redox species were 4,4-dimethyltriphenylamine (produced by Tokyo Chemical Industry Co., Ltd.) and bis(4-formylphenyl)phenylamine (produced by Tokyo Chemical Industry Co., Ltd.), the electrolyte salt was LiBF₄, and the second nonaqueous solvent was propylene carbonate (produced by FUJIFILM Wako Pure Chemical Corporation). A second liquid was thus obtained. The concentration of 4,4-dimethyltriphenylamine in the second liquid was 2.5 mmol/L. The concentration of bis(4-formylphenyl)phenylamine in the second liquid was 2.5 mmol/L. The concentration of LiBF₄ in the second liquid was 11 mol/L.

Next, an N-methylpyrrolidone (NMP) solution containing polyvinylidene fluoride (PVDF) (produced by Solvay Specialty Polymers Japan K.K., a weight-average molecular weight of 1,000,000 to 1,200,000) at a concentration of 8% by weight was prepared. Next, plate-shaped porous glass (produced by Akagawa Glass Co., Ltd.) with a diameter of 20 mm was set on a glass filter capable of being decompressed. The average pore size of the porous glass was 4 nm. The thickness of the porous glass was 200 μm. The porosity of the porous glass was 29%. The NMP solution was applied to an upper surface (first surface) of the porous glass, whereby a coating was formed. Next, a space adjacent to a lower surface (second surface) of the porous glass was decompressed. This created a pressure difference between a first space adjacent to the coating and a second space adjacent to the second surface, whereby pores of the porous glass were filled with the NMP solution. The coating was dried for one hour in such a state that a pressure difference is present. Next, the coating was dried for 14 hours in a vacuum thermostatic chamber adjusted to 80° C., whereby a metal ion-conducting membrane including a resin layer and a porous layer was prepared. In the metal ion-conducting membrane, the porous layer included a filler located in the pores of the porous glass. The thickness of the resin layer was about 50 μm.

The metal ion-conducting membrane was placed into a cell. The first liquid and the second liquid was poured into the cell such that first liquid and the second liquid were separated by the metal ion-conducting membrane. A negative electrode was immersed in the first liquid, and a positive electrode was immersed in the second liquid. The negative electrode used was made of stainless steel (SUS) foam. The positive electrode used was made of a carbon felt. An electrochemical cell of Example 1 was thus prepared.

### Electrochemical Evaluation

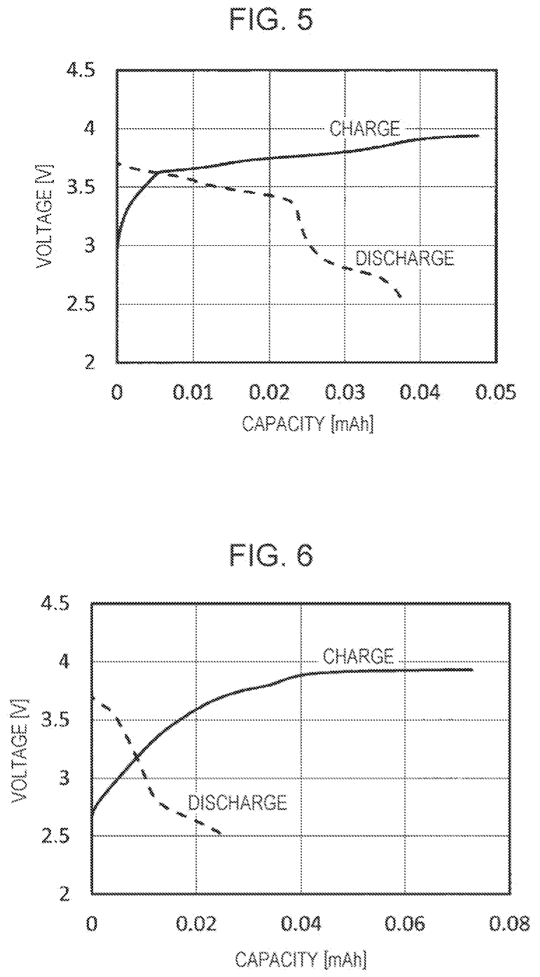

A charge/discharge test for the electrochemical cell of Example 1 was carried out using an electrochemical analyzer. FIG. 5 is a graph showing results of the charge/discharge test for the electrochemical cell of Example 1. The charge capacity of the electrochemical cell was 48 μAh. The discharge capacity of the electrochemical cell of Example 1 was 38 μAh. The charge/discharge efficiency of the electrochemical cell was 80%.

### Comparative Example 1

An electrochemical cell of Comparative Example 1 was prepared by the same method as that of Example 1 except that a single film of PVDF was used as a metal ion-conducting membrane. The thickness of the PVDF single film was 50 μm. Furthermore, a charge/discharge test for the electrochemical cell of Comparative Example 1 was carried out by the same method as that of Example 1. FIG. 6 is a graph showing results of the charge/discharge test for the electrochemical cell of Comparative Example 1. The charge capacity of the electrochemical cell of Comparative Example 1 was 73 μAh. The discharge capacity of the electrochemical cell of Comparative Example 1 was 25 μAh. The charge/discharge efficiency of the electrochemical cell was 34%.

The electrochemical cell of Example 1 had excellent charge/discharge efficiency as compared to the electrochemical cell of Comparative Example 1. This shows that the crossover of the first redox species, which is biphenyl, and the second redox species, which are 4,4-dimethyltriphenylamine and bis(4-formylphenyl)phenylamine, was suppressed in the electrochemical cell of Example 1. As described above, it is clear that, according to a metal ion-conducting membrane including a porous layer and a resin layer in contact with the porous layer, the crossover of redox species can be sufficiently suppressed.

A redox flow battery according to the present disclosure can be used as, for example, an electricity storage device or an electricity storage system.

What is claimed is:

1. A redox flow battery comprising:
a negative electrode;
a positive electrode;
a first liquid which contains a first nonaqueous solvent, a first redox species, and metal ions and which is in contact with the negative electrode;
a second liquid which contains a second nonaqueous solvent and which is in contact with the positive electrode; and
a metal ion-conducting membrane disposed between the first liquid and the second liquid,
wherein the metal ion-conducting membrane includes a porous layer and a resin layer which is in contact with the porous layer and which contains a fluorocarbon resin, and
the porous layer includes a porous body and a filler which is located in pores of the porous body and which contains a fluorocarbon resin.

2. The redox flow battery according to claim 1, wherein the fluorocarbon resin contained in the filler is the same as the fluorocarbon resin contained in the resin layer.

3. The redox flow battery according to claim 1, wherein the fluorocarbon resin contained in the resin layer includes polyvinylidene fluoride.

4. The redox flow battery according to claim 3, wherein a weight-average molecular weight of the polyvinylidene fluoride is greater than or equal to 300,000 and less than or equal to 1,200,000.

5. The redox flow battery according to claim 1, wherein a porosity of the porous body is greater than or equal to 20% and less than or equal to 50%.

6. The redox flow battery according to claim 1, wherein a content of the fluorocarbon resin in the metal ion-conducting membrane is greater than or equal to 16% by weight and less than or equal to 44% by weight.

7. The redox flow battery according to claim 1, wherein the porous body contains porous glass.

8. The redox flow battery according to claim 1, wherein a thickness of the porous layer is greater than or equal to 0.2 mm and less than or equal to 1.0 mm.

9. A method for manufacturing the metal ion-conducting membrane included in the redox flow battery according to claim 1, the method comprising:
(1) forming a coating by applying a solution containing a fluorocarbon resin to a first surface of a layer including the porous body;
(2) filling the pores of the porous body with the solution; and
(3) forming the porous layer and the resin layer by drying the coating after or concurrently with (2).

10. The manufacturing method according to claim 9, wherein (2) is performed in such a manner that a pressure difference is created between a first space adjacent to the coating and a second space adjacent to a second surface of the layer that is opposite to the first surface.

11. The manufacturing method according to claim 10, wherein the pressure difference is greater than or equal to 90 kPa and less than or equal to 99 kPa.
